(19) United States
(12) Patent Application Publication
(10) Pub. No.: US 2022/0187814 A1
(43) Pub. Date: Jun. 16, 2022

(54) COLLECTION AND USE OF DATA DISTRIBUTED THROUGHOUT INDUSTRIAL SYSTEMS

(71) Applicant: Schweitzer Engineering Laboratories, Inc., Pullman, WA (US)

(72) Inventor: Monika Devi Murugesan, Pullman, WA (US)

(73) Assignee: Schweitzer Engineering Laboratories, Inc., Pullman, WA (US)

(21) Appl. No.: 17/117,906

(22) Filed: Dec. 10, 2020

(51) Int. Cl. G05B 23/02; G06N 20/00; G06N 5/04

(52) U.S. Cl. CPC G05B 23/024; G06N 5/04; G06N 20/00

(57) ABSTRACT

The present disclosure pertains to the use and collection of data stored in systems used to monitor, automate, and/or protect industrial systems. In one embodiment, a distributed data collection system may collect distributed data from a plurality of devices that monitor equipment in an industrial system. The data may be aggregated and transmitted to a remote interface system through a data flow control device. The data flow control device may allow the aggregate data to be transmitted but may block other types of communication between the remote interface system and the distributed data collection system. The remote interface system may process the aggregate data and make the data available to operators of the industrial system. The analysis may include predictive maintenance analysis, predictive failure analysis, asset health monitoring, and efficiency improvements.

### TECHNICAL FIELD

The present disclosure pertains to the use and collection of data stored in systems used to monitor, automate, and/or protect industrial systems. More particularly, but not exclusively, the systems and methods disclosed herein may gather data from intelligent electronic devices (IEDs) in electric power systems and other industrial systems and use that data to identify a need for equipment maintenance or replacement.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates a simplified one-line diagram of an electric power delivery system consistent with embodiments of the present disclosure.

FIG. 2 illustrates a conceptual representation of a system for collection of distributed data from a plurality of IEDs in an industrial system and use of the collected data for improved operation of the industrial system consistent with embodiments of the present disclosure.

FIG. 3 illustrates a graph over time showing the number of times two motors were started before and after maintenance was performed consistent with embodiments of the present disclosure.

FIG. 4 illustrates a dashboard showing visualizations related to a plurality of motors in an industrial system consistent with embodiments of the present disclosure.

FIG. 5 illustrates a block diagram of a system to collect and use data distributed throughout an industrial system consistent with embodiments of the present disclosure.

FIG. 6 illustrates a flow chart of a method to collect and use data distributed throughout an industrial system consistent with embodiments of the present disclosure.

### DETAILED DESCRIPTION

Equipment used in industrial systems may be automated, controlled, or monitored using a wide variety of devices, such as IEDs, programmable logic controllers, computing platforms, and the like. Such devices commonly gather information about the equipment that relates to performance, reliability, efficiency, and a variety of other parameters. Such information can be used to identify a need for maintenance, identify potential issues, and improve efficiency; however, this information is commonly disbursed throughout a system. Further, such information is typically accessed by making a specific query to retrieve desired information. The format of the information may vary based on the type of equipment, the manufacturer of the equipment, and configuration of the device, leading to a lack of uniformity in information.

Still further, many industrial systems must implement strict network security measures to ensure that unauthorized users cannot gain access to such systems. Some systems (e.g., electric power systems, telephone networks, etc.) are critical infrastructure that may impact public health and safety and are essential to economic activity. Such security measures may impose significant constraints and preclude use of enterprise resource planning (ERP) systems that may be used in less secure applications. Commonly, reports related to equipment performance in critical infrastructure are gathered by physically connecting a computer to the device containing the information and manually accessing the information.

Gathering and analyzing data from such sources is time-consuming and effectively using the information can be difficult and require specialized knowledge of the equipment. Engineering resources with the knowledge to access and analyze such data are limited and costly, and as such, the information may go unused and may result in inefficiencies.

The inventors of the present disclosure have recognized the benefits associated with automating the gathering of distributed data in industrial systems and providing such data to operators. Access to such information allows operators to increase efficiencies by identifying and remedying potential issues that may reduce the life of equipment and/or making adjustments to improve operations. Further, gathering such data may enable use of various techniques to reduce the amount of time and/or level of skill necessary to interpret the data. For example, machine-learning algorithms may be used to analyze data and identify trends and potential solutions to maximize asset utilization. Still further, systems consistent with the present disclosure may operate in secure networks associated with critical infrastructure and may add advanced features (e.g., data aggregation, data visualization, predictive maintenance, etc.) to existing systems without replacing existing equipment.

As used herein, an IED may refer to any microprocessor-based device that monitors, controls, automates, and/or protects monitored equipment within a system. Such devices may include, for example, differential relays, distance relays, directional relays, feeder relays, overcurrent relays, voltage regulator controls, voltage relays, breaker failure relays, generator relays, motor relays, remote terminal units, automation controllers, bay controllers, meters, recloser controls, communication processors, computing platforms, programmable logic controllers (PLCs), programmable automation controllers, input and output modules, and the like. The term IED may be used to describe an individual IED or a system comprising multiple IEDs. Further, IEDs may include sensors (e.g., voltage transformers, current transformers, contact sensors, status sensors, light sensors, tension sensors, etc.) that provide information about the electric power system.

The embodiments of the disclosure will be best understood by reference to the drawings. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor do the steps need to be executed only once, unless otherwise specified.

In some cases, well-known features, structures, or operations are not shown or described in detail. Furthermore, the described features, structures, or operations may be combined in any suitable manner in one or more embodiments. It will also be readily understood that the components of the embodiments, as generally described and illustrated in the figures herein, could be arranged and designed in a wide variety of different configurations. For example, throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Several aspects of the embodiments disclosed herein may be implemented as software modules or components. As used herein, a software module or component may include any type of computer instruction or computer-executable code located within a memory device that is operable in conjunction with appropriate hardware to implement the programmed instructions. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. A module or component may comprise a single instruction or many instructions and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a non-transitory machine-readable medium having stored thereon instructions that may be used to program a computer or other electronic device to perform processes described herein. The non-transitory machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable media suitable for storing electronic instructions. In some embodiments, the computer or another electronic device may include a processing device such as a microprocessor, microcontroller, logic circuitry, or the like. The processing device may further include one or more special-purpose processing devices such as an application-specific interface circuit (ASIC), PAL, PLA, PLD, field-programmable gate array (FPGA), or any other customizable or programmable device.

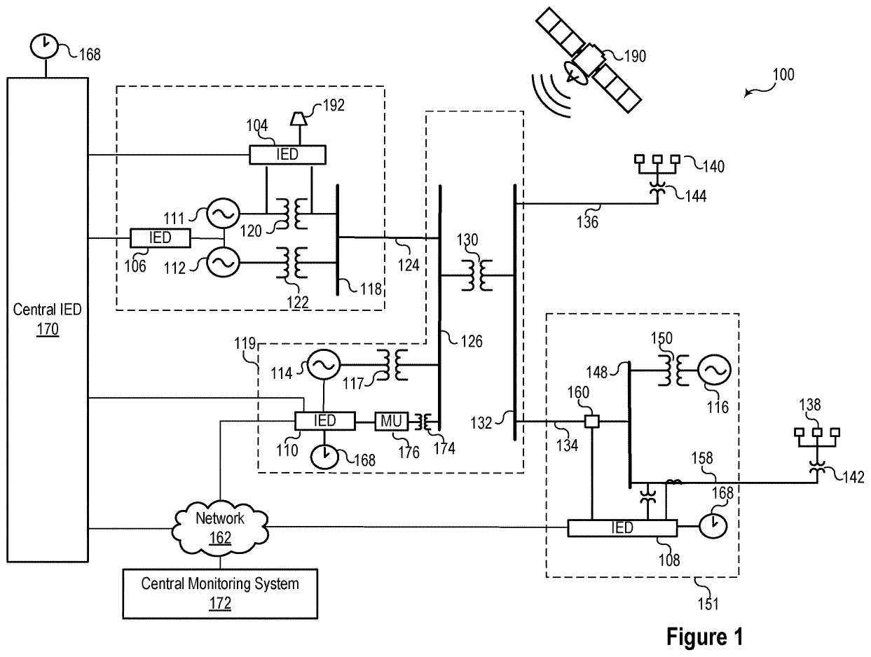

FIG. 1 illustrates a simplified one-line diagram of an electric power delivery system 100 consistent with embodiments of the present disclosure. Electric power delivery system 100 may be configured to generate, transmit, and distribute electric energy to loads. Electric power delivery systems may include equipment such as electrical generators (e.g., generators 111, 112, 114, and 116), transformers (e.g., transformers 117, 120, 122, 130, 142, 144, 150, and 174), power transmission and delivery lines (e.g., lines 124, 134, 136, and 158), circuit breakers (e.g., breaker 160), busses (e.g., busses 118, 126, 132, and 148), loads (e.g., loads 140 and 138) and the like. A variety of other types of equipment may also be included in electric power delivery system 100, such as voltage regulators, capacitor banks, and the like.

Substation 119 may include a generator 114, which may be a distributed generator, and which may be connected to bus 126 through step-up transformer 117. Bus 126 may be connected to a distribution bus 132 via a step-down transformer 130. Various distribution lines 136 and 134 may be connected to distribution bus 132. Load 140 may be fed from distribution line 136. Further, step-down transformer 144 in communication with distribution bus 132 via distribution line 136 may be used to step down a voltage for consumption by load 140.

Distribution line 134 may lead to substation 151 and deliver electric power to bus 148. Bus 148 may also receive electric power from distributed generator 116 via transformer 150. Distribution line 158 may deliver electric power from bus 148 to load 138 and may include further step-down transformer 142. Circuit breaker 160 may be used to selectively connect bus 148 to distribution line 134. IED 108 may be used to monitor and/or control circuit breaker 160 as well as distribution line 158.

Electric power delivery system 100 may be monitored, controlled, automated, and/or protected using IEDs, such as IEDs 104, 106, 108, 110, and 170, and a central monitoring system 172. In general, IEDs in an electric power generation and transmission system may be used for protection, control, automation, and/or monitoring of equipment in the system. For example, IEDs may be used to monitor equipment of many types, including electric transmission lines, electric distribution lines, current transformers, busses, switches, circuit breakers, reclosers, transformers, autotransformers, tap changers, voltage regulators, capacitor banks, generators, motors, pumps, compressors, valves, and a variety of other types of monitored equipment.

Central monitoring system 172 may comprise one or more of a variety of types of systems. For example, central monitoring system 172 may include a supervisory control and data acquisition (SCADA) system and/or a wide area control and situational awareness (WACSA) system. A central IED 170 may be in communication with IEDs 104, 106, 108, and 110. IEDs 104, 106, 108, and 110 may be remote from the central IED 170 and may communicate over various media such as a direct communication from IED 106 or over a wide-area communications network 162. According to various embodiments, certain IEDs may be in direct communication with other IEDs (e.g., IED 104 is in direct communication with central IED 170) or may be in communication via a communication network 162 (e.g., IED 108 is in communication with central IED 170 via communication network 162).

A common time signal 168 may be used to time-align measurements for comparison and/or synchronize action across system 100. Utilizing a common or universal time source may allow for the generation of time-synchronized data, such as synchrophasors. In various embodiments, the common time source may comprise a time signal from a GNSS system 190. IED 104 may include a receiver 192 configured to receive the time signal 168 from the GNSS system 190. In various embodiments, IED 106 may be configured to distribute the time signal 168 to other components in system 100, such as IEDs 104, 108, 110, and 170.

A voltage transformer 174 may be in communication with a merging unit (MU) 176. MU 176 may provide information from voltage transformer 174 to IED 110 in a format useable by IED 110. MU 176 may be placed near voltage transformer 174 and may digitize discrete input/output (I/O) signals and analog data, such as voltage measurements. These data may then be streamed to IED 110. In various embodiments, MU 176 may be located outside of a substation enclosure or control house, thus increasing safety by removing high-energy cables from areas where personnel typically work.

In embodiments consistent with the present disclosure, IEDs 104, 106, 108, and 110 may collect information about the equipment (e.g., generators, transformers, transmission lines, etc.) in system 100. In some embodiments, the information collected by IEDs 104, 106, 108, and 110 may be communicated to central IED 170. In one specific embodiment, central IED 170 is embodied as an SEL-3530 real-time automation controller (RTAC) available from Schweitzer Engineering Laboratories of Pullman, Washington.

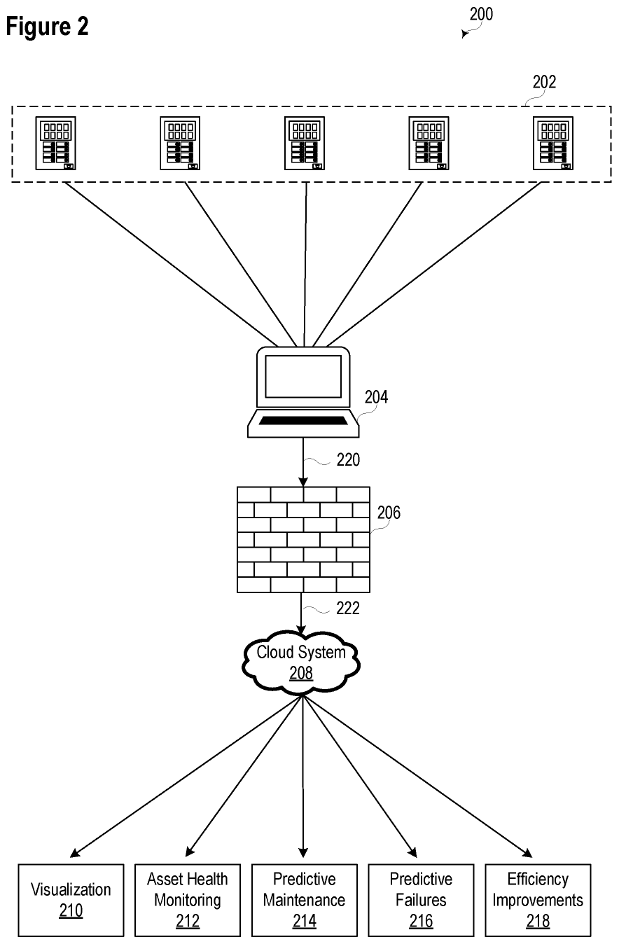

FIG. 2 illustrates a conceptual representation of a system 200 for collection of distributed data from a plurality of IEDs 202 in an industrial system and use of the collected data for improved operation of the industrial system consistent with embodiments of the present disclosure. During operation of the industrial system, IEDs 202 may collect a variety of types of status information associated with equipment in the industrial system. IEDs 202 may be embodied as existing devices that collect information, but that only provide such information in response to a query. Further, IEDs 202 may provide limited amounts of storage, and may purge data if the storage is full. In some embodiments, IEDs 202 may provide only text-based reporting and may lack the native ability to aggregate information from multiple devices and to generate visual representations of collected data. As one of skill in the art will appreciate, many existing devices lack these features; however, replacing these devices to implement advanced features (e.g., greater storage, aggregation of data, visualization of data, etc.) is costly and burdensome.

Computer 204 may be in communication with IEDs 202 and may collect data from IEDs 202. Computer 204 may include a variety of interfaces (e.g., serial ports, Ethernet ports, etc.) for communicating with various devices and may support various communication protocols used by IEDs 202. Further, computer 204 may include credentials used to connect to IEDs 202. Computer 204 may issue a command to each of the plurality of IEDs 202 to transmit data regarding monitored equipment in the industrial system. In response to the command, IEDs 202 may each transmit a report comprising information regarding equipment monitored by each IED.

Computer 204 and IEDs 202 may be positioned behind a firewall 206. Firewall 206 may strictly control communications between computer 204 and cloud system 208, thus reducing the potential for unauthorized access to computer 204. In general, firewall 206 may function as a data control device that limits communication between computer 204 and cloud system 208. In various embodiments, firewall 206 may allow data collected from IEDs 202 to be communicated from computer 204 to cloud system 208, as indicated by arrows 220 and 222. Firewall 206 may further allow certain types of requests to pass from cloud system 208 to computer 204 (e.g., user-initiated requests to poll data from IEDs 202) while blocking other types of requests. Strictly limiting and/or blocking communication from cloud system 208 to computer 204 may allow computer 204 to operate in crucial infrastructure and other high-security applications.

Data collected from IEDs 202 may be collected and analyzed in a cloud-based system, as represented by cloud system 208. Cloud system 208 may allow operators of the industrial system to access data collected from IEDs 202 without the difficulties described above and while maintaining the security of the system. Cloud system 202 may utilize machine-learning and/or predictive models to analyze data collected from IEDs 202 for use in a variety of applications. Further, cloud system 208 may offer greater storage capabilities, thus allowing data to be stored and analyzed for a longer, and potentially indefinite period of time.

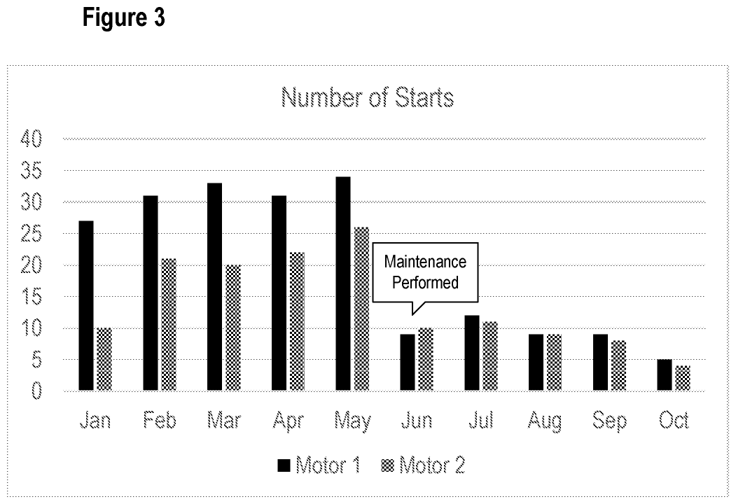

Cloud system 208 may generate visualizations 210 of data collected from IEDs 202. Cloud system 208 may gather text-based reports created by IEDs 202 and convert the data into a graphical format presented to a user. Visualization information may be sent to the user on a schedule or via on-demand polling. As discussed below in connection with FIG. 3, visualizations 210 may aid in the identification of potential issues to address.

Cloud system 208 may perform asset health monitoring 212 using data collected from IEDs 202. Cloud system 208 may track one or more health metrics associated with monitored equipment over time, and the health metrics may be used to determine asset health and trends. For example, if an IED monitors a motor, cloud system 208 may detect if the motor restarts more frequently than expected, draws more current than expected, exhibits a longer coasting time than expected, or deviates from any other baseline metric, the health of the motor may be rated poorly using the health metrics.

Cloud system 208 may use the data collected from IEDs 202 for predictive maintenance 214. Cloud system 208 may analyze a variety of criteria monitored by IEDs 202 to evaluate equipment while in operation and may perform such analysis either continuously or according to a schedule. Predictive maintenance 214 may reduce costs over routine or time-based preventive maintenance, which are performed based on a schedule rather than a need. A proactive maintenance approach may increase the useful life of systems at a lower cost by identifying potential problems based on data and avoiding the expenditure of resources on equipment that is operating within expected parameters.

Cloud system 208 may use data collected from IEDs 202 for predictive failure 216 analysis. Predictive failure 216 analysis may provide a warning of impending failure. System 200 may monitor electrical and/or mechanical parameters to identify impending failures. For example, cloud system 208 may monitor current and voltage signals of a motor in relation to baseline parameters to estimate a predicted time of a failure. Using such information, operators of system 200 may replace equipment that is likely to fail, thereby avoiding unplanned outages and allowing for equipment to be replaced at a time selected to minimize impact.

Cloud system 208 may identify efficiency improvements 218 based on data collected by IEDs 202. Cloud system 208 may monitor a variety of efficiency metrics, such as energy utilization, and compare the efficiency metrics over time and/or across devices to identify potential improvements. In some embodiments, the impact of a variety of settings associated with IEDs 202 may be analyzed to determine any impact on the performance of associated equipment. For example, where multiple motors are used to drive similar loads, a variety of settings may be used and analyzed to determine a combination of settings that optimizes a metric. When settings are identified that improve performance, cloud system 208 may alert operators of system 200 so that the improved settings can be implemented across the system. Further, data may be analyzed to identify improvements in processes associated with the industrial system. For example, efficiencies may be realized by distributing energy needs throughout the day based on fluctuating energy costs.

Cloud system 208 may represent any type of remote interface system that makes data available to operators. In various embodiments, the functions of cloud system 208 may be implemented using a server on a private network and/or accessible through the Internet using a virtual private network or other types of remote-access technologies.

FIG. 3 illustrates a graph over time showing the number of times two motors were started before and after maintenance was performed, consistent with embodiments of the present disclosure. The graph in FIG. 3 illustrates an example of a data visualization that may be generated based on information gathered from an industrial system including the two motors. The data for the period from January through May shows an increasing number of starts of both motors. The increasing number of starts per month may indicate that maintenance is needed. After maintenance is performed, the number of starts drops. Visualization of the data may aid in the identification of trends, such as the increasing number of starts, that may be more difficult to glean from text-based reports.

In some embodiments, machine-learning may be used to analyze the data in the period from January through May to determine that maintenance is necessary. A machine-learning algorithm may detect the increasing number of starts per month and may generate an alert or recommendation for a user. Alternatively, threshold values may be set to determine when maintenance should be performed. Still further, in some embodiments, the visualization may simply be provided to an operator on a schedule, and the operator may determine when maintenance should be performed.

Although FIG. 3 illustrates a plot showing the number of times per month two motors are started, similar visualizations may be utilized in other embodiments. For example, other criteria that may be visualized include motor starting current, motor coasting time, motor operating current, breaker trip count, breaker interrupt current, and the like.

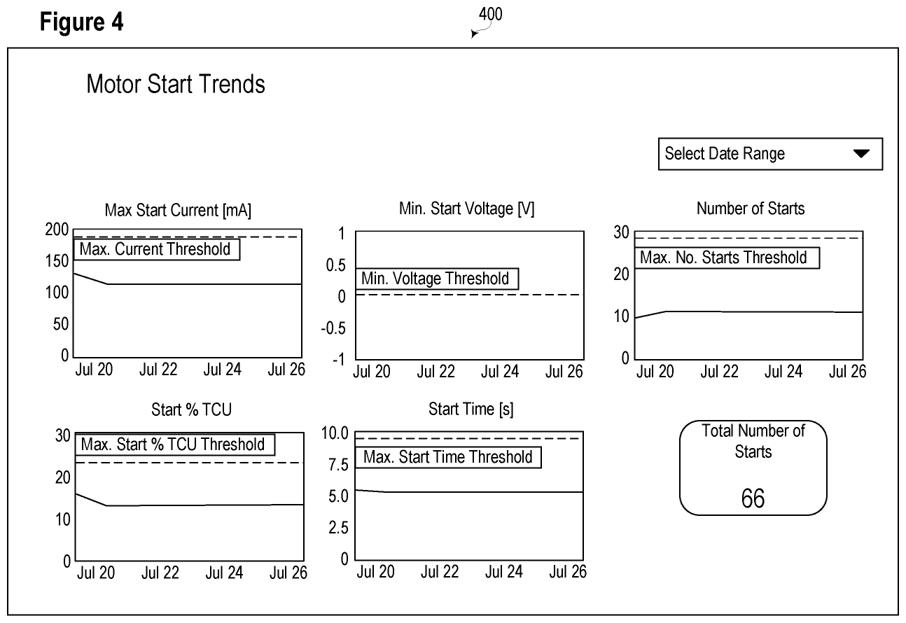

FIG. 4 illustrates a dashboard 400 showing visualizations related to a plurality of motors in an industrial system consistent with embodiments of the present disclosure. Dashboard 400 may be presented to a user as part of a system that allows a user to access visualizations of various parameters associated with an industrial system. In the illustrated embodiment, six parameters are illustrated, namely a plot of maximum start current, a minimum start voltage, a number of starts, a start % TCU, a start time, and a total number of starts. Various thresholds are also displayed. The thresholds may allow a user to quickly determine whether any of the criteria exceed any applicable threshold.

The information presented in dashboard 400 may allow an operator to identify trends or issues related to the operation of the plurality of motors. For example, an operator may periodically review dashboard 400 to assess the health of the system. Further, a system may provide alerts to prompt an operator to review the dashboard if any issues are detected.

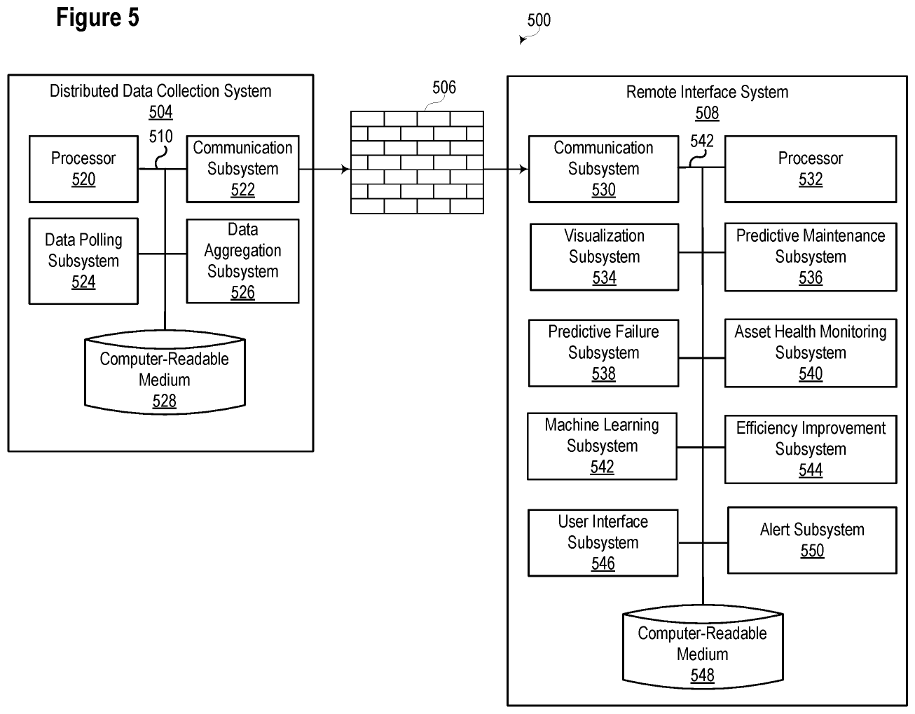

FIG. 5 illustrates a block diagram of a system 500 to collect and use data distributed throughout an industrial system consistent with embodiments of the present disclosure. System 500 may be implemented using hardware, software, firmware, and/or any combination thereof. In some embodiments, system 500 may comprise IEDs, while in other embodiments, certain components or functions described herein may be associated with other devices or performed by other devices. The specifically illustrated configuration is merely representative of one embodiment consistent with the present disclosure.

Processor 520 processes communications received via communication subsystem 522 and the other subsystems and components in distributed data collection system 504. Processor 520 may operate using any number of processing rates and architectures. Processor 520 may perform various algorithms and calculations described herein. Processor 520 may be embodied as a general-purpose integrated circuit, an application-specific integrated circuit, a field-programmable gate array, and/or any other suitable programmable logic device. Processor 520 may communicate with other elements in distributed data collection system 504 by way of bus 510. Processor 532 may operate similarly to processor 520.

Computer-readable medium 528 may comprise any of a variety of non-transitory computer-readable storage media. Computer-readable medium 528 may comprise executable instructions to perform processes described herein. Computer-readable medium 528 may comprise non-transitory machine-readable media such as, but not limited to, hard drives, removable media, optical disks, CD-ROMs, DVD-ROMs, ROMs, RAMs, EPROMs, EEPROMs, magnetic or optical cards, solid-state memory devices, or other types of media/machine-readable media suitable for storing electronic instructions. Such electronic instructions may be executed on processor 520. Computer-readable medium 548 may operate similarly.

Data polling subsystem 524 may collect information distributed in IEDs throughout an industrial system. Data polling subsystem 524 may provide interfaces for communicating with various devices (e.g., serial ports, Ethernet ports, etc.) and may support various communication protocols used by IEDs in the industrial system. Data polling subsystem 524 may include credentials used to connect to IEDs.

Data aggregation subsystem 526 may aggregate information collected by data polling subsystem 524 and provide the aggregate information to remote interface system 508. Information from data aggregation subsystem 526 may be transmitted via communication subsystem 522. The data may pass through a firewall 506. In some embodiments, firewall 506 may only allow information to be transmitted in the direction indicated by the arrows. Communication subsystem 530 may receive information from distributed data collection system 504.

Visualization subsystem 534 may generate a representation of data collected from distributed data collection system 504. In one specific embodiment, visualization subsystem 534 may generate the dashboard illustrated in FIG. 4. Other types of visualizations may also be generated. Such visualizations may allow users to identify trends or spot issues in the operation of the industrial system.

Predictive maintenance subsystem 536 may analyze a variety of criteria associated with monitored equipment in the industrial system to evaluate equipment while in operation and may perform such analysis either continuously or according to a schedule. Predictive maintenance may reduce costs over routine or time-based preventive maintenance, which are performed based on a schedule rather than a need.

Predictive failure subsystem 538 may use data collected from distributed data collection system 504 for predictive failure analysis. Predictive failure analysis may provide a warning of impending failure. Predictive failure subsystem 538 may monitor electrical and/or mechanical parameters to identify an impending failure. Using such information, operators may replace equipment that is likely to fail, thereby avoiding unplanned outages and allowing for equipment to be replaced at a time selected to minimize impact.

Asset health monitoring subsystem 540 may perform asset health monitoring using data collected from distributed data collection system 504. Information collected over time by distributed data collection system 504 may be used to determine asset health and trends. Various criteria for different types of equipment (e.g., motors, generators, transformers, breakers, etc.) may be monitored to detect variations from expected parameters or trends over time.

Machine-learning subsystem 542 may analyze data collected by distributed data collection system 504. Machine-learning subsystem 542 may be used in conjunction with any of visualization subsystem 534, predictive maintenance subsystem 536, predictive failure subsystem 538, and asset health monitoring subsystem 540. A variety of types of machine-learning algorithms and systems may be used in various embodiments.

Efficiency improvement subsystem 544 may identify efficiency improvements based on data collected by distributed data collection system 504. Efficiency improvements may be provided as suggestions by remote interface system 508. For example, when similar equipment is used, efficiency improvement subsystem 544 may compare the efficiencies of the equipment to identify the impact of various settings on efficiency.

A user interface subsystem 546 may allow users to access information provided by remote interface system 508. User interface subsystem 546 may manage user credentials and associate user credentials with permissions. User interface subsystem 546 may allow users to connect to remote interface system 508 through networks (e.g., private networks, the Internet, etc.) such that the information collected by system 500 is readily accessible and available for use.

An alert subsystem 550 may notify operators of an industrial system monitored by system 500 of various conditions. For example, an alert may be generated by alert subsystem 550 based on a predicted failure and/or a need for predictive maintenance. Such alerts may be helpful to ensure that users receive timely notification of potential issues. The alert may be embodied in a variety of ways. In various embodiments. For example, the alert may comprise a visual indicator on a dashboard, an electric notification (e.g., an email, an SMS message, etc.), an alarm, and the like.

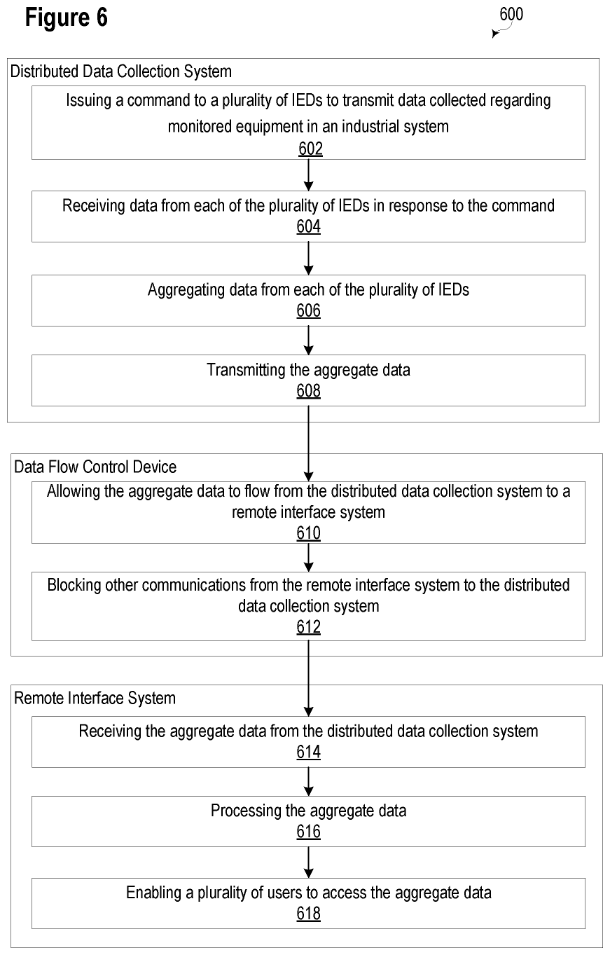

FIG. 6 illustrates a flow chart of a method 600 to collect and use data distributed throughout an industrial system consistent with embodiments of the present disclosure. At 602, a distributed data collection system may issue a command to a plurality of IEDs to transmit data collected regarding monitored equipment in the industrial system. The command may be accompanied by credentials required to access the data. In various embodiments, the command may be initiated by a user request or according to a schedule.

At 604, in response to the command, the distributed data collection system may receive data regarding monitored equipment from each of the plurality of IEDs. The data may include reports of data measurements, control actions, conditions, and other information related to the monitored equipment. In various embodiments, the data may be provided in a text-based format.

At 606, the data from each IED may be aggregated. Data may be aggregated based on various criteria. For example, data may be aggregated based on a type of equipment (e.g., data from a plurality of motors is aggregated) or based on a location (e.g., data from devices in a particular substation in an electric power system).

At 608, the aggregate data may be transmitted. In various embodiments, the transmitted data may first pass through a data flow control device. The data flow control device may limit communications between the distributed data collection system and a remote interface system. In various embodiments, the data flow control device may enforce security parameters that allow the distributed data collection system to operate in crucial infrastructure or other high-security applications.

At 610, the data flow control device may allow the aggregate data to flow from the distributed data collection system to the remote interface system. Various techniques may be used to allow the flow of data, such as using a firewall or a unidirectional security gateway.

At 612, the data flow control device may block other communication from the remote interface system to the distributed data collection system. Strictly controlling communications from the remote interface system may reduce the potential for unauthorized access to the distributed data collection system and/or an associated industrial system. In some embodiments, the data flow control device may permit certain types of traffic (e.g., user-initiated poll requests) to pass.

At 614, the remote interface system may receive the aggregate data from the distributed data collection system via the data flow control device. The data may be provided in the form of text-based information and may include information about the status of monitored equipment in the industrial network.

At 616, the remote interface system may process the aggregate data. In various embodiments, the data may be processed in various ways to generate visualizations, to enable predictive maintenance, to identify efficiency improvements, and/or to predict equipment failures. Based on the processed data, a user may be able to visualize the data. Further, machine-learning may be used to enable predictive maintenance and/or predictive failure.

At 618, a plurality of users may be enabled to access the aggregate data. Various criteria may be specified to associated users with specific permissions (e.g., certain users may be allowed to view all data while other users can only view a subset of the data). The remote interface system may interface with other types of systems and provide the collected data to such systems for further analysis and/or use.

While specific embodiments and applications of the disclosure have been illustrated and described, it is to be understood that the disclosure is not limited to the precise configurations and components disclosed herein. Accordingly, many changes may be made to the details of the above-described embodiments without departing from the underlying principles of this disclosure. The scope of the present invention should, therefore, be determined only by the following claims.

What is claimed is:

1. A system, comprising:
a distributed data collection system, comprising:
a data polling subsystem to:
issue a command to a plurality of devices in an industrial system to transmit data collected by each of the plurality of devices regarding monitored equipment in the industrial system; and
receive data from each of the plurality of devices in response to the command;
a data aggregation subsystem to generate aggregate data collected from the plurality of devices; and
a first communication subsystem to transmit the aggregate data;
a remote interface system in communication with the distributed data collection system and configured to process the aggregate data, comprising:
a second communication subsystem to receive the aggregate data from the first communication subsystem;
a visualization subsystem to generate a representation of the aggregate data; and
a user interface subsystem to enable a plurality of users to access the aggregate data; and
a data flow control device disposed between the first communication subsystem and the second communication subsystem and configured to allow the aggregate data to flow from the distributed data collection system to the remote interface system and to block other communications from the remote interface system to the distributed data collection system.

2. The system of claim 1, wherein the remote interface system further comprises a machine-learning subsystem to analyze the aggregate data and to identify an anomaly based on the aggregate data collected from the plurality of devices.

3. The system of claim 2, wherein the remote interface system further comprises a predictive maintenance subsystem to identify a need for maintenance of monitored equipment based on the anomaly in the aggregate data.

4. The system of claim 2, wherein the remote interface system further comprises a predictive failure subsystem to identify a predicted failure of monitored equipment based on the anomaly in the aggregate data.

5. The system of claim 4, wherein the remote interface system further comprises an alert subsystem to generate an alert representing the predicted failure.

6. The system of claim 1, further comprising an efficiency improvement subsystem to monitor an efficiency metric associated with monitored equipment and to generate a suggestion to improve the efficiency metric.

7. The system of claim 1, further comprising an asset health monitoring subsystem to track a health metric of monitored equipment in the industrial system.

8. The system of claim 1, wherein the data polling subsystem issues the command to a plurality of devices in an industrial system to transmit data based on a polling request received from an operator through the remote interface system.

9. The system of claim 1, wherein the remote interface system further comprises a non-transitory computer-readable storage medium to store the aggregate data collected from the plurality of devices.

10. The system of claim 1, wherein the industrial system comprises a crucial infrastructure system.

11. A method, comprising:
collecting, using a distributed data collection system, information from a plurality of devices in an industrial system by:
issuing, using a data polling subsystem, a command to the plurality of devices to transmit data collected by each of the plurality of devices regarding monitored equipment in the industrial system;
receiving, using the data polling subsystem, data from each of the plurality of devices in response to the command;
aggregating, using a data aggregation subsystem, data from each of the plurality of devices to generate aggregate data;
transmitting, using a first communication subsystem, the aggregate data to a remote interface system;
processing, using a remote interface subsystem in communication with the distributed data collection system, the aggregate data received from the distributed data collection system by:
receiving, using a second communication subsystem, the aggregate data from the first communication subsystem;
generating, using a visualization subsystem, a representation of the aggregate data; and
enabling, using a user interface subsystem, a plurality of users to access the aggregate data; and
controlling, using a data flow control device disposed between the first communication subsystem and the second communication subsystem, communication between the distributed data collection system and the remote interface system by:
allowing the aggregate data to flow from the distributed data collection system to the remote interface system; and
blocking other communications from the remote interface system to the distributed data collection system.

12. The method of claim 11, further comprising analyzing, using a machine-learning subsystem, the aggregate data and identifying an anomaly based on the aggregate data collected from the plurality of devices.

13. The method of claim 12, further comprising identifying, using a predictive maintenance subsystem, a need for maintenance of monitored equipment based on the anomaly in the aggregate data.

14. The method of claim 12, further comprising identifying, using a predictive failure subsystem, a predicted failure of monitored equipment based on the anomaly in the aggregate data.

15. The method of claim 14, wherein the remote interface system further comprises an alert subsystem to generate an alert representing the predicted failure.

16. The method of claim 11, further comprising an efficiency improvement subsystem to monitor an efficiency metric associated with monitored equipment and to generate a suggestion to improve the efficiency metric.

17. The method of claim 11, further comprising an asset health monitoring subsystem to track a health metric of monitored equipment in the industrial system.

18. The method of claim 11, wherein the data polling subsystem issues the command to a plurality of devices in an industrial system to transmit data based on a polling request received from an operator through the remote interface system.

19. The method of claim 11, wherein the remote interface system further comprises a non-transitory computer-readable storage medium to store the aggregate data collected from the plurality of devices.

20. The method of claim 11, wherein the industrial system comprises a crucial infrastructure system.
